(19) United States
(12) Patent Application Publication
(10) Pub. No.: US 2019/0131822 A1
(43) Pub. Date: May 2, 2019

(54) One Touch Charger

(71) Applicants: Peter Kulukurgiotis, Cambridge, MD (US); Stella Kulukurgiotis, Cambridge, MD (US)

(72) Inventors: Peter Kulukurgiotis, Cambridge, MD (US); Stella Kulukurgiotis, Cambridge, MD (US)

(21) Appl. No.: 15/796,833

(22) Filed: Oct. 29, 2017

(51) Int. Cl. H02J 50/12; H04B 5/00; H02J 7/02; H02J 7/00

(52) U.S. Cl. CPC H02J 50/12; H04B 5/0037; H02J 2007/0049; H02J 7/0047; H02J 7/025

(57) ABSTRACT

The current invention is a wireless charger for QI devices. The charger contains a 3500 mAh battery, powered by the alternating current sent to the transmitter coil by the transmitter circuit. Alternating current flowing within the transmitter coil creates a magnetic field which extends to the receiver coil when within a specified distance to charge a device. The Charger contains an integrated circuit allowing the product to turn off two minutes after the device is fully charged. The charger has a heat shield located underneath the LED screen to prevent overheating.

### CROSS-REFERENCES TO RELATED APPLICATIONS (IF ANY)

None.

### BACKGROUND

### 1. Field of the Invention

This invention relates to chargers and more particularly chargers that charge electronic devices like smart phones.

### 2. Description of Prior Art

The world is becoming increasingly wireless More and more people are using electronic communication devices such as smartphones and tablets to keep in touch. It is important for work and emergencies to keep your phone charged for access.

It is frustrating and can even be dangerous when someone need to communicate and find themselves out of power.

There is still room for improvement in the art.

### SUMMARY OF THE INVENTION

The current invention is a wireless charger for QI devices and non Qi compatible devices. The charger contains a 3500 mAh battery, powered by the alternating current sent to the transmitter coil by the transmitter circuit. Alternating current flowing within the transmitter coil creates a magnetic field which extends to the receiver coil when within a specified distance. The magnetic field generates current within the receiver coil of the device. Current flowing within the receiver coil is then converted into direct current (DC) by the receiver circuit, which charges the battery of the electrical device.

The Charger contains an integrated circuit allowing the product to turn off two minutes after the device is fully charged. There's even a heat shield located underneath the LED screen to prevent overheating. The Charger is fully waterproof, thanks to electronic waterproof coating. The state-of-the-art LCD screen projects battery life, letting the user know how much charge they have left at all times.

It is an improvement over existing art.

### BRIEF DESCRIPTION OF THE DRAWINGS

Without restricting the full scope of this invention, the preferred form of this invention is illustrated in the following drawings:

FIG. 1 shows the wireless charger in a charging position;

FIG. 2 shows another view of the charger in a charging position;

FIG. 3 shows a right side view of the charger in a charging position;

FIG. 4 shows a left right side view of the charger in a charging position; and

FIG. 5 shows some of the components of the wireless charger.

### DESCRIPTION OF THE PREFERRED EMBODIMENT

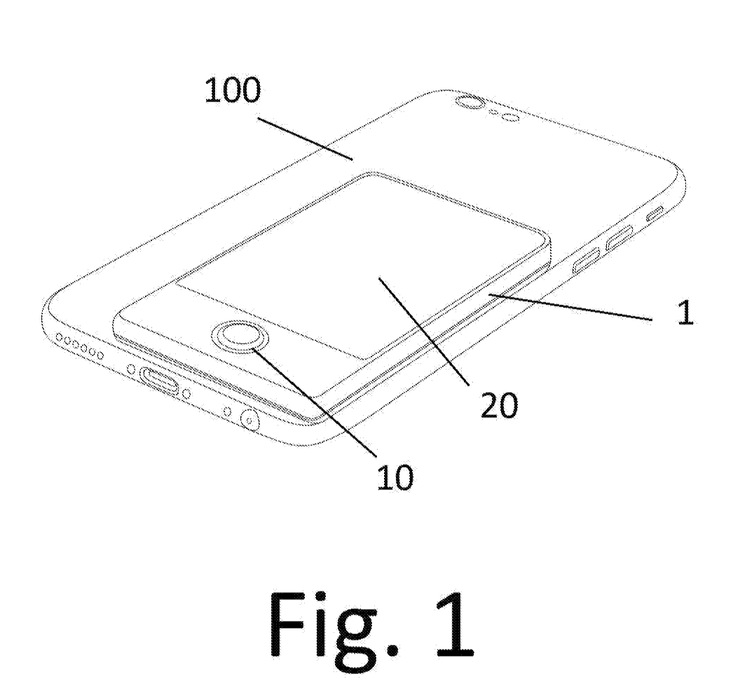

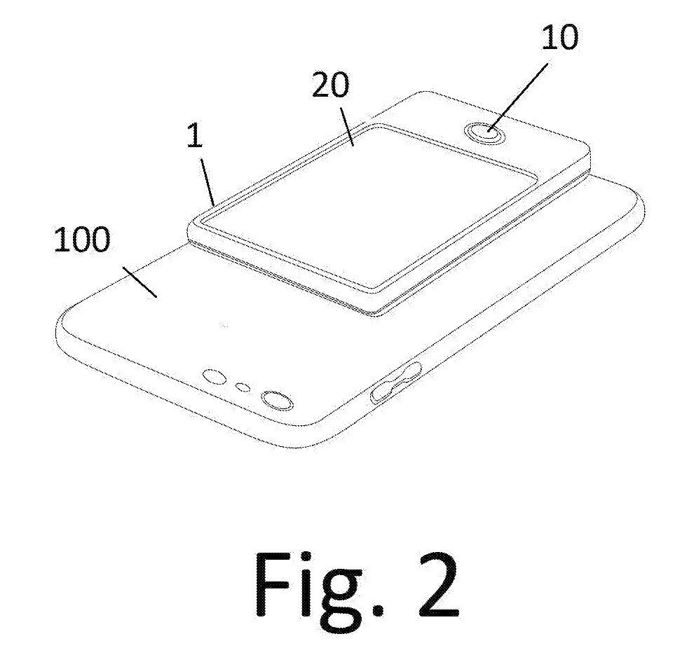

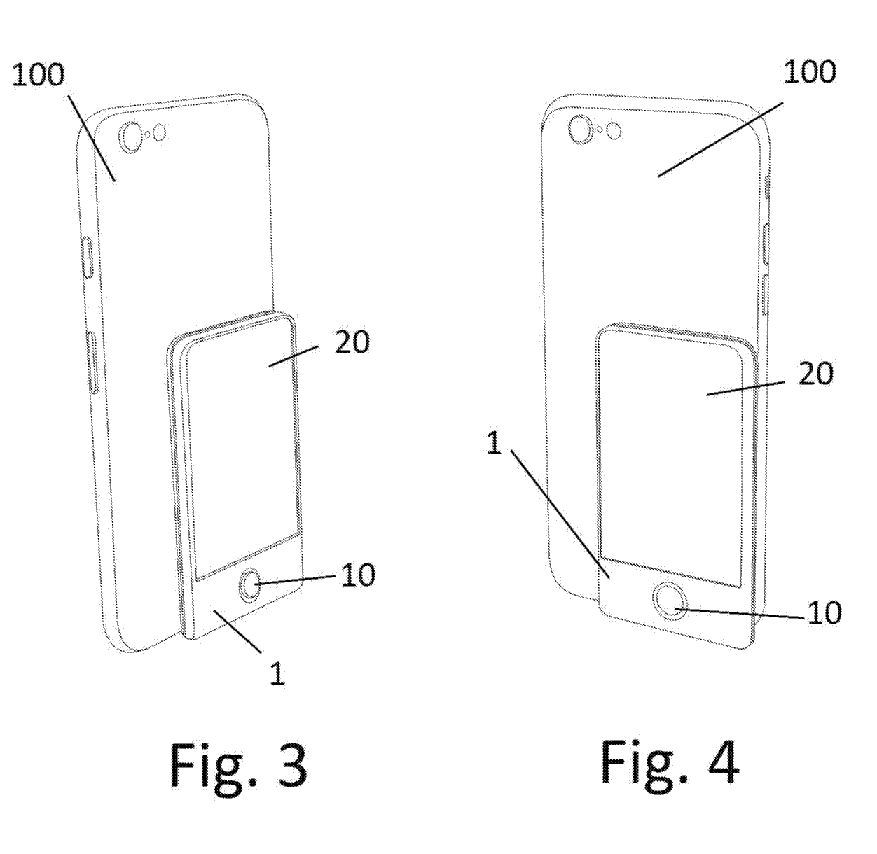

As shown in FIGS. 1 through 5, the current invention is a wireless charger 1 used to wirelessly charge an electronic device 100.

The charger 1 is designed to charge smartphones and tablets and and any device QI or non QI compatible. Qi is an open interface standard developed by the Wireless Power Consortium for inductive charging over distances of up to 4 cm (1.6 inches). The charger 1 is placed next to the device 100 to be charged as shown in FIG. 1 through 4 to charge via resonant inductive coupling.

The Charger 1 is portable within a thin rectangular case with rounded edges in the preferred embodiment. The design of the current invention is such that the devices 100 can be charged without having to set them down.

In the preferred embodiment, the charger 1 charges itself with RF wave technology using a antenna 30 as a source of electricity produced called radio frequency waves. This allows the charging of the devices 100 without the need to set it down and with no need for cables or wires.

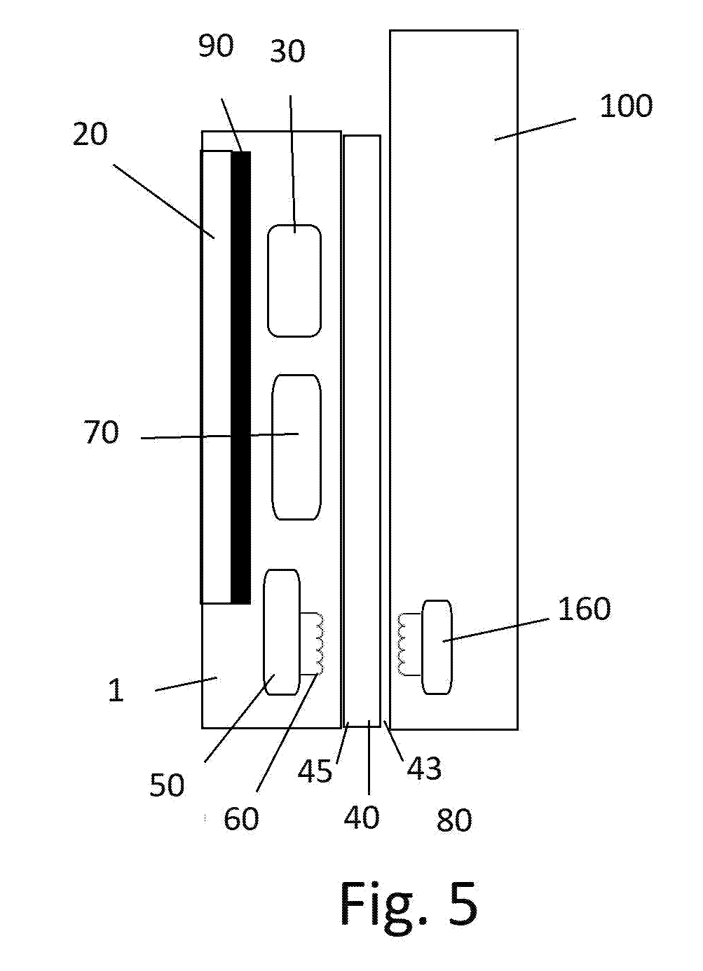

The charger 1 will have a magnetic stick pad 40 as shown in FIG. 5. The magnetic stick pad 40 has two sides: adhesive 43 and magnetic 45. The adhesive side sticks to the back of the device 100, while the magnetic side attaches to the Charger 1. It's that simple for constant charge on the go.

As shown in FIG. 5, the Charger 1 contains a 3500 mAh battery 50, powered by the alternating current sent to the transmitter coil 60 by the transmitter circuit 70. Alternating current flowing within the transmitter coil creates a magnetic field which extends to the receiver coil 160 in the device when within a specified distance. The magnetic field generates current within the receiver coil of the device 100. Current flowing within the receiver coil 160 is then converted into direct current (DC) by the receiver circuit, which charges the battery of the electrical device 100.

The charger 1 contains an integrated circuit 70 allowing the product to turn off two minutes after the device is fully charged. There's even a heat shield 90 located underneath the LED screen to prevent overheating. The charger 1 has an low power LCD 20 screen projects battery life, letting the user know how much charge they have left at all times.

The Charger 1 is fully waterproof having an electronic waterproof coating.

Advantages

The current invention changes the way devices are charged for good. No more setting down and waiting. No more need for cables, wires and annoying adaptor plugs. No more USB cords or heavy case chargers taking up space. It sticks conveniently to the back of the device.

Although the present invention has been described in considerable detail with reference to certain preferred versions thereof, other versions are possible such as different tension means, bobber shapes and sizes and different colored lights. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A charger comprising:
Having case where a battery is powered by an alternating current sent to a transmitter coil by the transmitter circuit creating a magnetic field which extends to the receiver coil a device to be charged.

2. The charger according to claim 1 further comprising:
Where the case is rectangular in shape.

3. The charger according to claim 1 further comprising:
Where the battery is a 3500 mAh battery.

4. The charger according to claim 1 further comprising:
Having magnetic stick pad with two sides: an adhesive and magnetic side where the adhesive side sticks to the back of the device and the magnetic side attaches to the device.

5. The charger according to claim 1 further comprising:
Having an integrated circuit.

6. The charger according to claim 5 further comprising:
Having the integrated circuit turn off the device two minutes after the device is fully charged.

7. The charger according to claim 1 further comprising:
Having an LED screen that shows battery life.

8. The charger according to claim 7 further comprising:
Having a heat shield located underneath the LED screen.
